(19) United States
(12) Patent Application Publication
(10) Pub. No.: US 2018/0007975 A1
(43) Pub. Date: Jan. 11, 2018

(54) METHOD AND UNDERWEAR SYSTEM FOR IMPROVED MALE GENITAL COMFORT

(71) Applicant: Jordan Blake Crump, Tulsa, OK (US)

(72) Inventor: Jordan Blake Crump, Tulsa, OK (US)

(21) Appl. No.: 15/713,677

(22) Filed: Sep. 24, 2017

Related U.S. Application Data
(63) Continuation of application No. 15/605,967, filed on May 26, 2017.

(51) Int. Cl. A41B 9/02; A61H 19/00; A61H 7/00; A41D 13/05; A41B 9/00

(52) U.S. Cl. CPC A41B 9/023; A41D 13/0525; A41B 9/004; A41B 9/026; A41B 9/001; A61H 7/002; A61H 19/32; A41B 2500/30; A41B 2400/32; A61H 2201/1645; A61H 2201/165; A61H 2201/1692

(57) ABSTRACT

An underwear system utilizing an inner panel design which acts to reduce the chafing discomfort and loss of feeling that circumcised boys and men experience from damaging friction caused by the daily wear of rough underwear.

### TECHNICAL FIELD

The present method and system are related to wearable garments, men's health and more specifically methods and systems that support issues exclusive to the genital comfort of circumcised men.

### BACKGROUND

The damages caused by male circumcision have not been commonly discussed until recently. It is apparent also and not surprisingly that underwear has not been designed to address such issues or at least effectively until now.

Without the foreskin (or long enough foreskin) to protect the glans, it becomes exposed, resulting in its callousing (keratinization) and altered appearance exclusively from constant exposure to friction and air. Additionally, circumcision results in loss of 50-75% of foreskin, a loss of at least 10,000-20,000 specialized erotogenic nerve endings. A study by Sorrells et al. (2007) had mapped fine-touch pressure thresholds in the adult penis in both circumcised and uncircumcised men, in comparing the two populations. They learned also that the glans in the circumcised male is less sensitive to fine-touch pressure than that of the uncircumcised (intact) male. Since it has become controversial in the 1960's, there has been a 77% decrease in infant circumcision.

Many sexual dysfunctions are suspected to be associated with circumcision. Sexual dysfunctions such as the loss of sensitivity in the glans and remaining foreskin. Researchers surveyed 300 men and found that circumcised men had a 4.5 times greater chance of suffering from ED than non-circumcised men. Circumcised penises can experience up to a 75% reduction or more in sensitivity or sensory potential compared to intact members, per a study in the British Journal of Urology International.

The present system enables the user to minimize the destructive friction which causes this sensitivity loss if the foreskin is no longer there (or when not covering) to protect the penis tissues. This results in improvements to most of the known issues related to sensitivity loss, mainly erectile dysfunction, premature ejaculation, and loss of fine touch sensitivity in a man's erogenous zones. Premature ejaculation is understood to induce a man to perform faster more frequent thrusts to compensate for the loss, rather than more delicate or slower coitus maneuvers typical of men with more sensitive organs, which is understood by personal observation to help prolong ejaculation. Erectile dysfunction from either or both loss of interest in sexual matters and decreased stimulation over the long term, which is understood through personal experience to cause atrophy and weakening of the penis.

In addition to resolving the issue of chafing discomfort and restoring a loss of feeling, the present system provides users with a plethora of other benefits that any user with a penis can enjoy and experience whether circumcised or not. Some naturally circumcised men (born with shorter than normal foreskin) and uncircumcised men may take advantage of any or all the described benefits as well. Said benefits being comfort, health and maintaining an improved penis sensitivity than would otherwise be experienced with conventional underwear designs.

### DEFINITIONS

Most terms used herein are to be taken as having their customary English meaning, unless specifically defined.

The term “micro-suede” throughout all sections is to mean a fine napped fabric and is associated with the following terms in product information and/or advertising, to include but not limited to: 1. Ultrasuede, 2. Stretch suede, 3. Alcantara, 4. Luxury suede, 5. Artificial suede, and 6. Micro suede.

The term “outer shell” throughout all sections is to mean the fabric body to which the penis isolation chamber system is integrated, retrofitted or attached/attachable to. The “outer shell” is to represent all forms of men's underwear except individual penis pouches that cover only the penis shaft and/or scrotum. This is to include, by way of example and not by limitation: 1. Boxers, 2. Boxer Briefs, 3. Trunks, and 4. Pant Style (i.e. Long johns, thermals). It is recommended, though, for the inside surface area of penis pouches, socks, or slip-on type products to be lined with micro-suede.

The term “penis tissues” through all sections is to mean the exposed portions of the penis that comprise of the foreskin and penis glans in whole or in part and can be covered or uncovered (exposed).

The term “penis entrapment” through all sections is to mean the prevention of penis contact to a surface not comprised of micro-suede.

### PROBLEMS RESOLVED OR MITIGATED BY THE PRESENT SYSTEM

### 1. Loss of Feeling and Discomfort/Pain—Caused by Chafing and Excessive Dryness of Exposed Penis Tissues.

One popular response to resolving loss of feeling and regaining lost benefits of intact foreskin was the creation of foreskin restoration methods such as U.S. Pat. No. 6,579,227B2, which has become a leader in that specific industry. This method, however, is very time consuming and uncomfortable for most to endure to the end. Other ideas of accomplishing the same effect include pouches and covers which cover and protect the glans, but they are without the degree of convenience of the present invention. There is an element of inconvenience to such devices in that they are an additional step a person may do. There is good news now for those seeking to regain at least some lost benefits without enduring the restoration process or adding extra steps in dressing.

Since circumcision is associated with erectile dysfunction because of either psychological or desensitization or both. Products and inventions as of current attempting to address erectile dysfunction and/or desensitization are generally limited to creams, ointments, pharmaceutical drugs, pumps and manual exercises. They all attempt to do the same as the present system. The “Manhood” pouch from Canada, a rubber foreskin replacement called “SenSlip” and a medical underwear invented by Musa Morgan of Cape Town, South Africa are the only available remedies for men dealing with these issues. Mr. Morgan's underwear is limited to medical post-surgery trauma assisted healing allowing the penis to be in only an upright position and doesn't claim to improve penis sensitivity by daily wear as is accomplished successfully by the present system.

### 2. Visible Incontinence.

U.S. Pat. No. 6,569,135 B1, U.S. Pat. No. 6,115,847 A, and U.S. Pat. No. 6,336,919 B1 have attempted to address this problem. The device of U.S. Pat. No. 8,250,677 B2 appears to work well for incontinence, but lacks convenience of the present system and the ability to wick moisture by not utilizing micro-suede which does so effectively. The rest are virtually limited to patented designs that are some form of padding insert of enhanced diaper, but almost all are dedicated to resolving incontinence issues. I claim that the present system is effective at reducing embarrassing incontinence incidents.

3. Erectile Dysfunction—It can be logically deduced and thus understood that penis sensitivity can be inversely correlated to erectile dysfunction through a recent study by Bollinger and Van Howe in the “International Journal of Men's Health”, which compares the Viagra use between intact men with circumcised men.
They found that circumcised men are 4.5 times more likely to use erection stimulation drugs, such as Viagra. One can only conclude from another study that intact men are significantly more sensitive to fine touch pressure, that any form of reversal of sensitivity loss in circumcised men will reduce the future use of said pharmaceutical drugs.

This is understood to be accomplished by maintaining higher sensitivity levels than would otherwise be experienced.

### 4. Excessively Dry Penis Tissues.

5. Penis Sticking to the Scrotum and/or Legs.

“U.S. Pat. No. 7,178,174 B2” and “U.S. Pat. No. 7,958,571 B2” are designs which employ a bifurcated mesh scrotum pouch or sling. U.S. Pat. No. 7,958,571 employs two inner bottom side panels. There are many other designs that employ the use of special folds or hoists, scrotal relief sacks to separate the penis from the scrotum and/or keep the penis in one place, but these designs do not account for material type as a means of reducing the pooling causing the sticking aside from physical separation being an answer to said problem. None have made specific claim to micro-suede for any of the described and claimed benefits.

### 6. Excessive Penis Movement.

This problem is mitigated by means of the extra supporting resistance and partial separation of the penis isolation chamber from its outer shell resulting in minimal penis movement.

### 7. Unwanted Erections.

This problem is mitigated by means of reduced friction which itself is understood to induce and/or prolong these events as a result of the extra stimulation said friction causes.

### 8. Development of Erectile Dysfunction.

This problem is mitigated by means of increased sensation as a result of the penis tissues having prolonged exposure to the penis isolation chamber, especially if said chamber is comprised of micro-suede upon its surfaces as is preferred.

This is a result of the hammock like effect and added tension pressed about the mass of the penis which thereby limits its movement during rigorous movements or activity, resulting in not only in decreased chafing as mentioned before, but also to enable the user in maintaining comfortable control of the penis.

### DESCRIPTION OF METHOD

The penis tissues of circumcised men experience friction constantly in any physical activity whether sitting, standing, running or any type of shifting movements the body may do. It became understood that this was a key culprit in the desensitization of the penis and since then attempts were made to mitigate this problem. The development of the present system resulted from an observation that the sensitivity of exposed penis tissues was found to be increased to a noticeable degree when the penis tissues contacted only micro-suede (to include all varieties of it) for an extended period in prototype testing.

The only time it is not expected to improve sensitivity is for the newly circumcised that begin using the present system directly after surgery, as the penis can only maintain its sensitivity to a limited extent with fabric of any kind without the natural skin adequately covering it. It is understood that a natural penis will always be more sensitive than a circumcised one.

Therefore, the present document is the first claim that micro-suede is capable of increasing sensitivity as a side effect of more substantially mitigating friction discomfort of the penis tissues. The re-sensitization effects were also found to be repeatable when switching to and from both conventional soft underwear of various materials and micro-suede. Upon doing this, the ability to feel the fabric upon the penis tissues is increased noticeably, but the increases are felt to such a degree as to cause discomfort and pain when wearing conventional underwear, which were previously not experienced before any exposure to micro-suede. The pain and discomfort is eliminated upon the return of the micro-suede. So, it is therefore highly unlikely the result of a placebo effect. It therefore exhibits a strong potential for users to develop an addiction to. Due to this effect, it has been concluded that the surfaces which contact the penis will be preferably comprised of micro-suede.

Noticeable and strong indications of sensory change were noted on a consistent basis. This is an extremely positive effect since being able to feel constant sensation implies constant friction damage, but because there is a general lack of damaging friction with the present system's claim of micro-suede fabrics, there is nothing to be felt and hence little to no damage can be expected to occur. A true improvement in quality of life for millions of men.

The observed effects theoretically resulting from two different friction reducing actions upon the keratinized mucus membranes of the penis tissues. One being the actions being sliding layers between the outer shell and penis isolation chamber, and the other action being the shifting overlay and rolling action of the tiny fibers in micro-suede fabrics which contact the penis tissues directly and consistently.

If the outer shell is grabbed or pulled in anyway, it will simply slide over the outside face of the penis isolation chamber, thus buffering the penis from being dragged. The tiny fibers being an additional means of friction reduction, said fibers acting as a frictionless and soft anchor for the penis.

Micro-suede surface texture provides a unique effect upon any surface it touches in that the tiny free standing and lying fibers act to decrease the grating effect caused by dragging of non-napped fabric. Whether standing upright or laid over, the tiny surface fibers of micro-suede fabrics are understood to produce a cushioning effect upon the skin cells in comparison to non-napped knits, thereby decreasing the friction by more evenly distributing the surface pressure upon the skin or membranes of the glans. It is also far more yielding to skin cells under pressure, tension and/or movements.

The folding and circling action of the micro-suede fibers, in theory, allows the penis to experience virtually no friction during micro-movements of the body. Given that there are very small unnoticeable movements of fabric against the penis tissues when a man is sitting or at rest, this can be expected to result in a significant improvement to the overall health of the penis tissues given the alternative condition of constant friction if the user wears conventional underwear designs.

A penis isolation chamber comprised of micro-suede on its surfaces sufficiently acts to eliminate the skin-grating effect, which is speculated to constitute a form of causation for excessive build-up of keratins on the penis tissues and would thus explain the increased sensitivity when exposure to harsher fabrics ceases. It is also speculated that fabric construction made from the thinnest and softest available fibers in a denser formation will further increase these same beneficial effects.

### Fabric, Moisture and Sensitive Penis Tissues

The exposure to micro-suede style fabric knit types and all its forms (stretch-suede, ultra-suede etc.) has been observed to induce higher moisture content of the penis tissues, especially when said tissues are immersed on all sides, an effect not experienced with conventional underwear. The water wicking nature of the microsuede is speculated to be a contributing cause. Said observed effect is known by a visible change in the hue and texture of said tissues resulting in a wet skin appearance in the form of a light sheen.

This effect is also observed more frequently during long periods of minimal movement when the penis tissues are least disturbed against the fabric. The penis tissues affected become sticky when recently worn due to the extra hydration, which will dry after exposure to air in a short time. Said effect is not nearly to the extent of a freshly expose uncircumcised (natural) penis tissues, but to some degree in-between circumcised and natural.

The tissues of the glans consist of mucous membranes such as those found in the mouth and eyelids. The result of circumcision results in the loss of not only a simple piece of skin, but the loss of an adequate saturation of the natural mucosa produced by the mucous membranes of the penis tissues, which are called the “smooth mucosa”.

It is understood that the smooth mucosa should be allowed to saturate the keratinized glans tissue for extended periods of time to theoretically induce conditions that enable degradation of the keratin and to restore the upper mucosa cells to near ideal health. The mucosa membranes of the penis tissues, like any other mucosa cells, are understood to be fragile. The purpose of the mucosa membranes is understood to be to inundate other tissues with a thick protective fluid layer as a form of immune system support and cell injury prevention.

It is my understanding that it may be possible to induce restorative effects to the remaining nerves and other sensory related tissues. This will hopefully provide a limited reversal of the thick layer of keratinization, which will allow the user to maintain a thinner layer of keratins, bringing healthier nerve cells closer to the surface, bestowing the respective owner with a more fulfilling sexual experience.

When there is positive pressure from within the general frontal portion proximate to the penis, a unique effect occurs upon the penis tissues. The term “positive pressure” is to mean the point of atmospheric pressure from increased relative humidity and/or heat in the environment approximate to the penis tissues which allows the penis tissues to be saturated with mucus, as is more natural. The intonation and texture of the penis glans will slightly darken and have a slight sheen, which itself varies depending on humidity and pressure of its environment.

Said effect is such that the glans adopts a permanent sheen and at times a wet or moist look as opposed to the dull flat tone and dry look common to a circumcised penis.

### DESCRIPTION OF METHOD TO SYSTEM

Micro-suede (including stretch suede and all other forms) has been found among the common fabric construction types currently available to be not only the most effective, but by a significant margin at reducing the friction which leads to sensitivity loss when the penis is exposed to it on a regular basis.

It is understood that an additional supportive means of mitigating penis friction in underwear is the construction of a penis isolation chamber. Such a chamber is in by itself sufficient to protect those men with expose penis tissues even if it is constructed or comprised out of conventional non-napped fabric. When combined with the friction mitigation of micro-suede fabrics, a partially free penis isolation chamber is a most effective means to minimize friction for the penis tissues which are otherwise dragged across the outer shell consistently when walking or running, body shifting, and/or any other actions which may move or grab the outer fabric shell. Therefore, a penis isolation chamber having surfaces comprised of micro-suede fabric and that separate the penis from the movement of the main fabric pieces or piece (also referred to as the “outer shell” throughout) is an effective means to mitigate this damaging uncomfortable friction. The sliding action of the fabric layers upon each other act to mitigate damaging friction even without a micro-suede surface. For this reason, the present system does not require micro-suede to mitigate penis friction. However, micro-suede acts to further reduce said friction significantly. For this reason, micro-suede is preferred to be used in conjunction with a penis isolation chamber that buffers the penis from the movement of the outer shell.

There are other forms of protection claimed, such as forms to protect only from the scrotum and legs without regard to fabric chafing or sensitivity improvement. If this function is desired, the perfect designs have been realized and are claimed herein being a total penis protection system.

Namely, the embodiments not utilizing micro-suede perform said function.

### DETAILED DESCRIPTION OF THE PRESENT SYSTEM

The embodiments as illustrated in the drawings are the refined result of many different configurations of prototypes being tested thoroughly for a most efficient balance of comfort and effectiveness in function.

It is preferred that the outer shell be made of fabric and be soft, elastic and snug. Said outer shell may comprise of either one panel or multiple attached panels comprised of fabric or any combination of fabric and other material types.

The ideal and preferred type fibers utilized throughout are preferably cellulosic due to their supreme softness, strength, and durability. Any knit form is acceptable for the outer shell. It should be reminded that the outer fabric shell can be represented by any garment designed to conform to a man's waist, hips and legs generally. This means, that any existing underwear can be retrofitted to be transformed into the present underwear system. Said underwear is to include, but is not limited to: 1. Boxer's, 2. Boxer briefs, 3. Briefs, 4. Trunks, and 5. Activewear, and 6. Pant Style Underwear.
The penis isolation chamber and single panel designs claimed herein are intregable to the front inner face of outer fabric shell that conforms to the hips, torso and thighs generally.

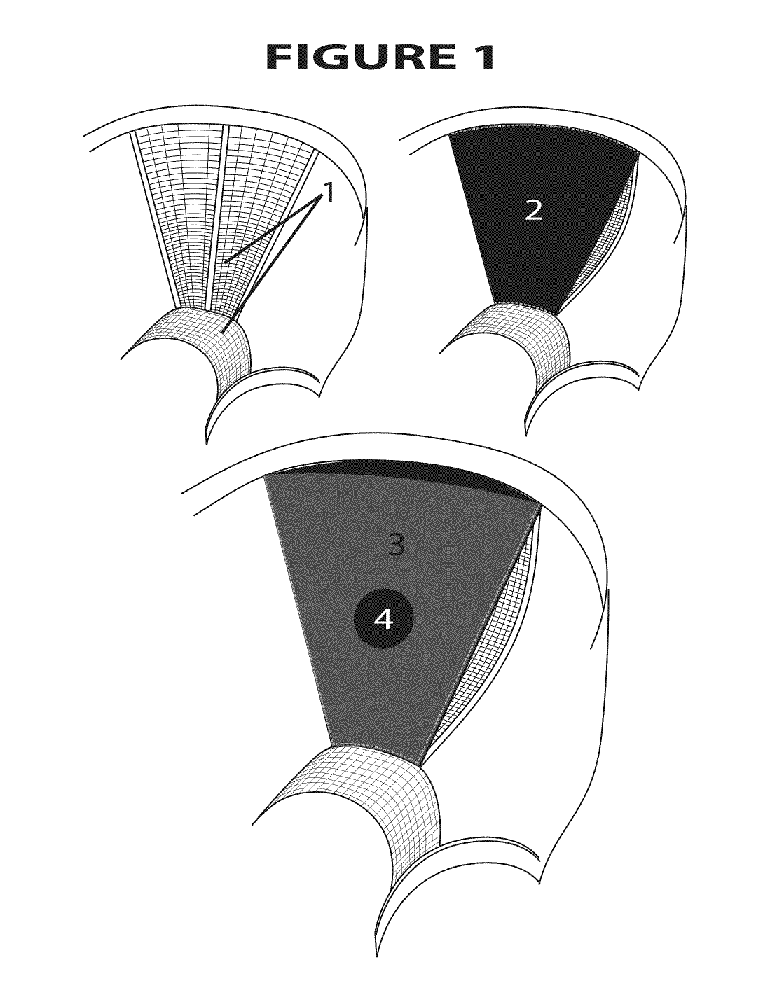

The approximate dimensions of the said isolation chamber being large enough to reliably capture a man's penis. The approximate size relation to the outer shell is a good indicator of said dimensions, though they may be adjusted by a person skilled in the art to accommodate any size penis. A top end width of between 6 to 10 inches is preferred and a bottom end width between 3 and 5 inches is preferred for the preferred embodiment illustrated in FIG. 1. This is not to limit the dimensions to such, simply to give a person skilled in the art a better understanding of the present system.

The open space on the top end of the penis isolation chamber must be large enough to fit an adult hand.

Both the penis isolation chamber and single panel designs may be attached to the outer shell by any means.

It is important that the side ends and bottom end of the penis isolation chamber are closed. Some embodiments may or may not have an open top end.

### DESCRIPTION OF THE PREFERRED EMBODIMENT

The best mode is illustrated in FIG. 1.

### 1. Outer Shell

The best mode utilizes an elastic and snug boxer brief style outer shell as the snug nature of the shell allows for better securement and adjustment of the penis. Said outer shell also employs the optional scrotal cooling mesh as shown in the drawings. Said illustration of mesh as part of the outer shell does not limit said outer shell to the shown design in the drawings, but is by way of example only. The front portions of the shell as illustrated employ optional cooling mesh to allow for further and multi-lateral cooling to the user's groin generally

For improved crotch tension control and ride-up prevention, the leg bands shall be constructed out of elastic bands, the noun rather than the adjective. It is my understanding that no underwear has been commercially produced utilizing said elastic bands and that I recommend its utilization for all undergarments if applicable, either for male or female, as a means to prevent ride-up and maintain tension about the legs.

### 2. Penis Isolation Chamber

The preferred embodiment as shown in FIG. 1 shall be comprised of stretch micro-suede. The default preferred style of micro-suede utilized is double-sided of any weight. Single-sided embodiments must have the softest sides facing inward if the embodiment is comprised of a “penis isolation chamber”. If the embodiment is a single panel, then the softest side must face towards t The bottom edge of the penis isolation chamber may be partially unattached, for example to allow a center through space for cooling and/or to slightly enhance friction mitigation.

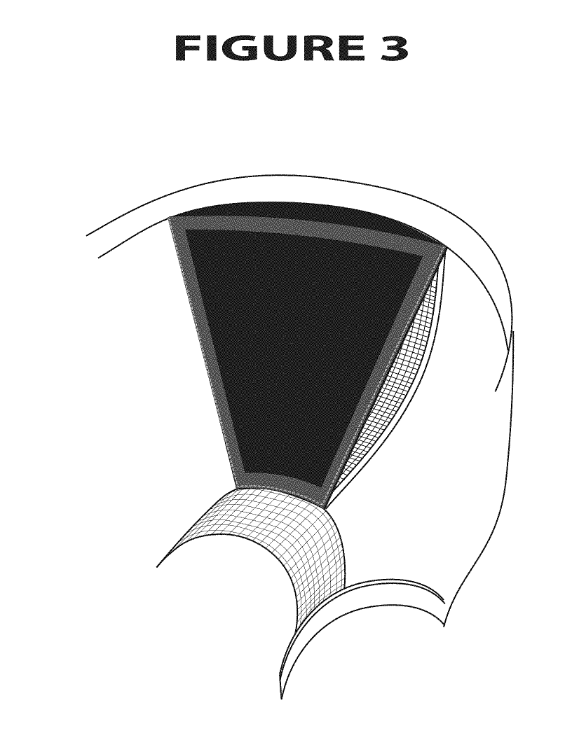

The penis access port of embodiment having a penis isolation chamber is preferred to be approximately four to eight inches in circumference and may be rounded or angular in shape, but may extend to near its ends as illustrated in FIG. 3.

Note that the top portion is open between the layers of the penis isolation chamber in FIGS. 1,2, 3 and 6. This is to enable the user easier convenience of penis insertion and adjustment. Another benefit to said opening is that it allows the user to flip down the waistband and readily exposing the penis for urination or sexual activity without requiring the user to first extract the penis from the penis isolation chamber.

Also note in FIGS. 1, 2, 3, 5 how the side ends of said penis isolation chamber are unattached to the outer shell as to allow free side to side movement to mitigate penis chafing/friction while the user is in motion.

The penis isolation chamber generally takes the form of a trapezoid as illustrated in the drawings. Said general trapezoidal shape being wider on top and tapers down to smaller width nearing the bottom of the attachment point of the outer shell. Said outer shell attachment points being at the approximate locations indicated and comprising dimensions sufficient to comfortably house the penis in both up, side and down positions.

### BRIEF DESCRIPTION OF THE DRAWINGS

The outer shell design in the drawings represents the preferred embodiment, which is the “boxer brief” style with optional cooling mesh. The white sections within the black lines represent the outer fabric shell structure. The gray section, where applicable, represents the user side of the penis isolation chamber and to indicate there is an interior space between two layers. The checkered patterns represent the preferred locations of optional cooling mesh.

### FIG. 1

The embodiment herein represents the best mode of the present system and an embodiment within the scope of claims 1 and 2.
This embodiment is preferred to be formed by two panels as illustrated to form a cavity/interior space in which the penis is housed, being prevented from contacting the legs, abdominal areas, and the scrotum. The seams of said two-piece embodiment are preferred to be facing outward as to prevent further penis chafing. The optional cooling mesh may be replaced by any other fabric material, this is simply by way of example and to illustrate the best mode.
FIG. 1 demonstrates a construction sequence for the preferred embodiment of the penis isolation chamber and as a guide to understand the construction of the other embodiments in the other drawings.
It may also, if the user desires, to be made of a single layer of fabric, as opposed to two separate pieces of fabric. If this is the case, the outward facing side of the penis isolation chamber shall be construed to mean “outer layer” of the penis isolation chamber and likewise for the inward facing side. Said single layer form may resemble in its construction the likeness of a “wrapped soft taco”.
1. Outer fabric shell.
2. Outer layer of penis isolation chamber.
3. Inner layer of penis isolation chamber.
4. Penis access port.

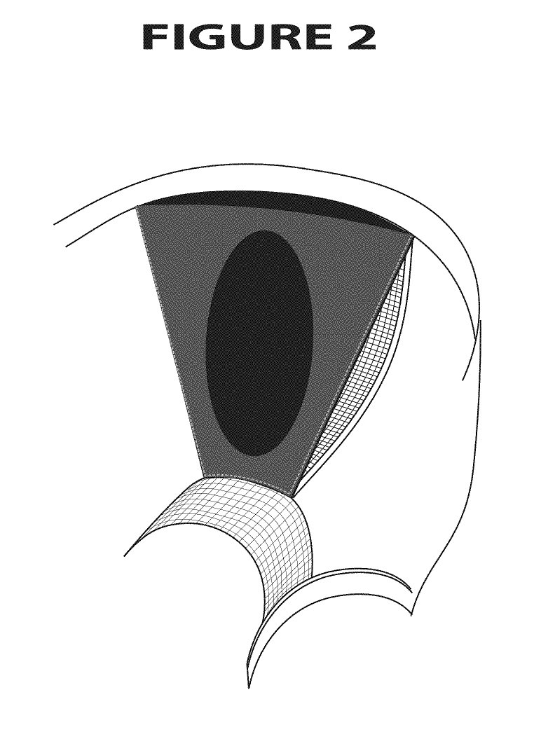

### FIG. 2

This is an embodiment illustrating a version of the “penis isolation chamber” within the scope of claim 1.
Note how the penis access port is larger and oval shape in comparison to FIG. 1.

### FIG. 3

This is an embodiment illustrating a version of the “penis isolation chamber” within the scope of the claims 1 and 2. FIG. 3 being a representation of the approximate boundaries of claim 1.
Note the large and angular penis access port and smaller inner face of the penis isolation chamber in gray.

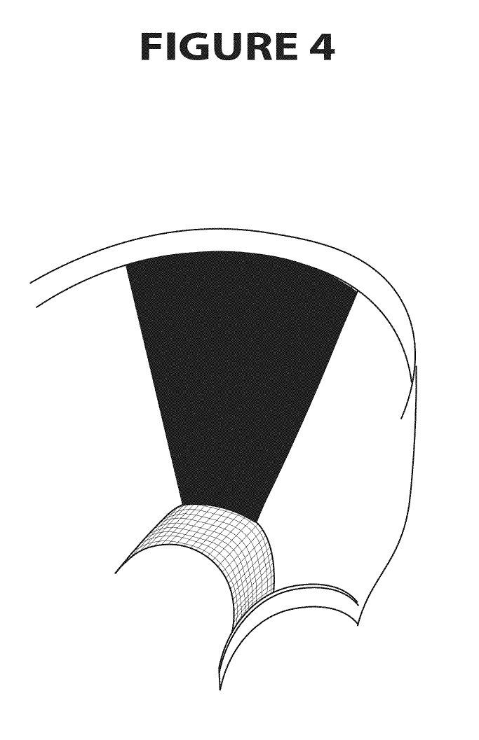

### FIG. 4

This is an embodiment illustrating a version of the “single panel” design within the scope of claim 10.
This embodiment is the simple pouch version. It is a micro-suede fabric panel attached to the front portions of the outer shell. This is for users who desire a simpler design that can still give them friction mitigation and sensitivity improvement. The panel is preferably expanded to aid the purposes described herein.

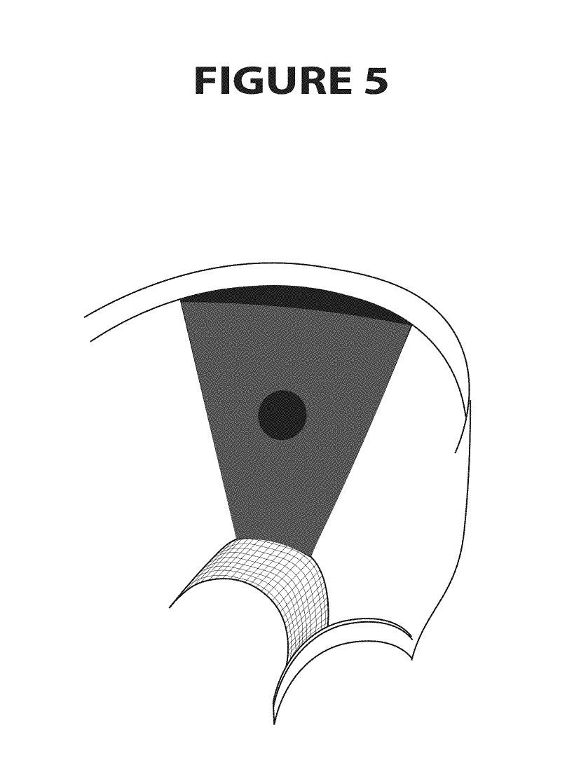

### FIG. 5

This is an embodiment illustrating a version of the “penis isolation chamber” within the scope of claim 8.
All ends of the penis isolation chamber in this embodiment are wholly attached to the inner face of the outer fabric shell.
This version is preferred for users who desire the option to not rely on the lateral movement of a partially free penis isolation chamber as a means of penis friction mitigation.
If the penis isolation chamber has its sides wholly attached it will lose some friction mitigation due to losing the ability to counter the movement of the outer shell, but said chamber will still remain effective for the purposes claimed and described herein.

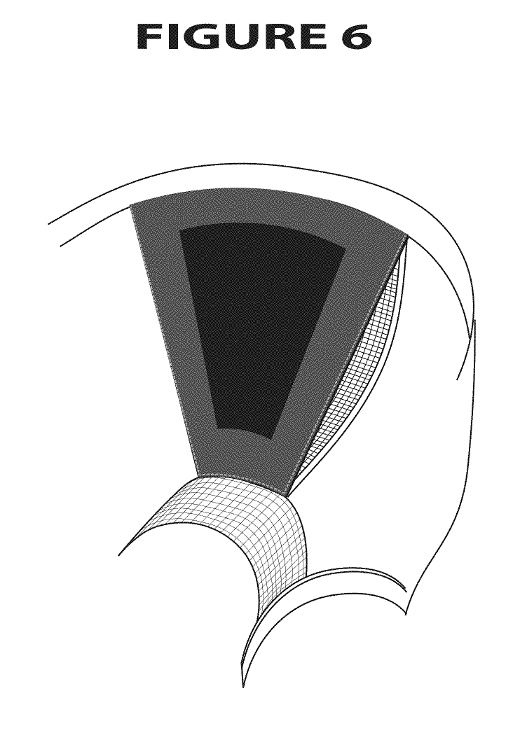

### FIG. 6

This is an embodiment illustrating a version of the “penis isolation chamber” within the scope of claim 3. Note that this embodiment does not have an open space on the top end of the penis isolation chamber, but has its side ends unattached just as the preferred embodiment in FIG. 1.

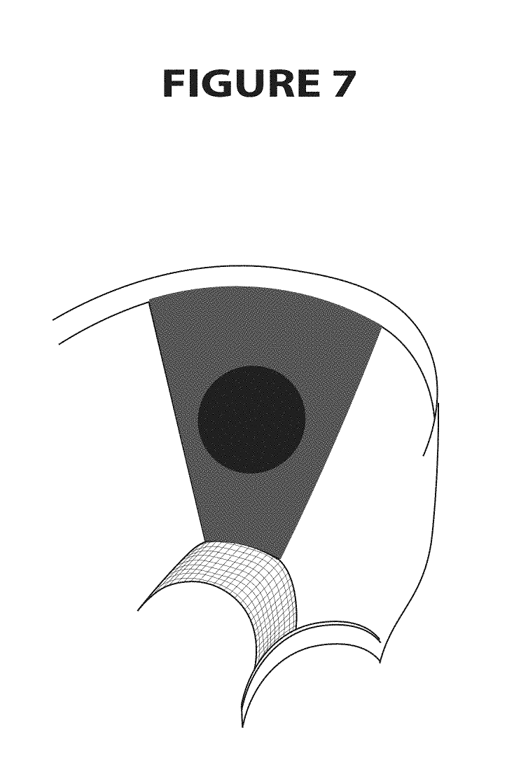

### FIG. 7

This is an embodiment illustrating a version of the “penis isolation chamber” within the scope of claim 6.

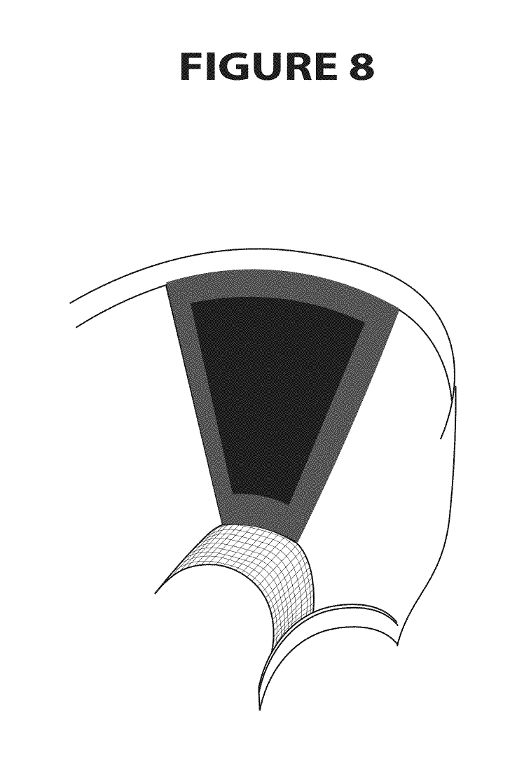

### FIG. 8

This is an embodiment illustrating a version of the “penis isolation chamber” within the scope of claim 6. Note that the access port is angular and large. Note also that this embodiment does not have an open space on the top end of the penis isolation chamber.

I claim:

1. A men's underwear system, said system comprising:
A hip, thigh/leg and torso conforming fabric shell and a penis isolation chamber, said chamber having a top end, a bottom end and two side ends, said top and bottom ends being attached to the interior front face of said shell, said side ends being left unattached; and
said penis isolation chamber having a penis access port on the face of said chamber, said face facing towards the user; and
the penis isolation chamber having a top portion with an open space, said space giving the user handy top-down access to the interior of said chamber.

2. The underwear system as set forth in claim 1, wherein said penis isolation chamber being comprised of micro-suede.

3. A men's underwear system, said system comprising:
A hip, thigh/leg and torso conforming fabric shell and a penis isolation chamber, said chamber having a top end, a bottom end and two side ends, said top and bottom ends being attached to the interior front face of said shell, said side ends being left unattached; and
said penis isolation chamber having a penis access port on the face of said chamber, said face facing towards the user; and

5. The underwear system as set forth in claim 3, wherein said penis isolation chamber being comprised of micro-suede.

6. A men's underwear system, said system comprising:
A hip, thigh/leg and torso conforming fabric shell and a penis isolation chamber, said chamber having a top end, a bottom end and two side ends, said ends being attached to the interior front face of said shell; and
said penis isolation chamber having a penis access port on the face of said chamber, said face facing towards the user; and

7. The underwear system as set forth in claim 8, wherein the penis isolation chamber being comprised of micro-suede.

8. A men's underwear system, said system comprising:
A hip, thigh/leg and torso conforming fabric shell and a penis isolation chamber, said chamber having a top end, a bottom end and two side ends, said ends being attached to the interior front face of said shell; and
said penis isolation chamber having a penis access port on the face of said chamber, said face facing towards the user; and
the penis isolation chamber having a top portion with an open space, said space giving the user handy top-down access to the interior of said chamber.

9. The underwear system as set forth in claim 8, wherein the penis isolation chamber being comprised of micro-suede.

10. A men's underwear system, said system comprising: a hip, thigh/leg and torso forming fabric shell and a fabric panel, said panel being attached to the inner front face of said shell, said panel having a top end, a bottom end and two side ends, said top, bottom and side ends being attached to said face of said shell, said fabric panel being further comprised of micro-suede.

11. A method for improving human penis sensitivity, said method comprising generally consistent contact of the penis to micro-suede.
